(19) United States
(12) Patent Application Publication
(10) Pub. No.: US 2023/0351432 A1
(43) Pub. Date: Nov. 2, 2023

(54) Systems And Methods Of Facilitating Merchant Coupon Distribution On A Blockchain Network

(71) Applicants: Hongwei Zhu, San Jose, CA (US); Ning Li, San Jose, CA (US)

(72) Inventors: Hongwei Zhu, San Jose, CA (US); Ning Li, San Jose, CA (US)

(21) Appl. No.: 18/138,114

(22) Filed: Apr. 23, 2023

Related U.S. Application Data
(60) Provisional application No. 63/335,480, filed on Apr. 27, 2022.

(51) Int. Cl. G06Q 30/0226; G06Q 20/38; G06Q 30/0601; G06Q 20/40; G06Q 20/12; G06Q 20/06; G06Q 20/10

(52) U.S. Cl. CPC G06Q 30/0233; G06Q 20/389; G06Q 20/38215; G06Q 20/3829; G06Q 20/3825; G06Q 30/0637; G06Q 20/4014; G06Q 20/12; G06Q 20/065; G06Q 20/381; G06Q 20/108; G06Q 30/0609

(57) ABSTRACT

System and method of providing secured coupon redemption with reward distribution in a blockchain (BC) network. A merchant pays for coupon coins to the BC network. When a consumer attempts to redeem a coupon associated with a purchase order, both the merchant and the consumer digitally sign a redemption request and send to the BC network for validation. The request may contain an encrypted order, an encrypted consumer key and an encrypted consumer key, and both signatures. Upon successful validation, the BC network can execute a smart contract to deduct the coupon coin balance and issue reward in the form of BC ownership coin to involved parties.

### CROSS-REFERENCE TO RELATED APPLICATION

This application claims priority to U.S. Provisional Patent Application Ser. No. 63/335,480, filed on Apr. 27, 2022, the content of which is incorporated herein by reference in its entirety.

### TECHNICAL FIELD

The description herein relates to the field of blockchain technologies, and more specifically, to using a blockchain platform to facilitate merchant coupon distribution.

### BACKGROUND

Merchant certificates, such as coupons, gift certificates, vouchers, etc., can be generated and distributed through various forms of coupon service in both digital space and physical space, e.g., mail, newspaper, automated mechanisms through email, or website advertisement, etc.

Merchants typically pre-pay a substantial price for the coupon service, e.g., based on the volume of coupons to be distributed or duration of the coupon advertisement. For example, a display advertisement platform or network commonly relies on “Clicks and Impressions” as their metric for success. That is, the advertisement cost to a merchant is calculated based on the number of clicks or impressions by potential consumers. The drawback is that typically a significant portion of coupons are ended up being unused, causing economic waste for the merchant. Also, when a merchant pays for an advertisement service, the merchant is charged regardless of the actual amount of business that is brought by an advertisement.

A blockchain network is a decentralized, distributed digital ledger that records transactions on interconnected computers or nodes, rather than relying on control by a centralized authority like a bank or government agency.

In a blockchain network, each node stores a copy of the ledger, which is updated and validated by a consensus mechanism, such as proof-of-work or proof-of-stake. Once a transaction is verified, it is added to the ledger as a new block, forming a chain of information that is tamper-proof and transparent.

Blockchain networks can enable secure, peer-to-peer transactions without the need for intermediaries, lowering costs and increasing efficiency. Blockchain networks can also improve transparency and trust, as all transactions are recorded on a public ledger that can be audited by anyone.

Smart contracts are self-executing contracts with the terms of the agreement between buyer and seller being directly written into lines of code. They are executed automatically when certain predetermined conditions are met, without involving human intermediaries, such as like lawyers or notaries.

Smart contracts are built on blockchain technology and operate on a decentralized network, making them resistant to fraud and hacking. They are transparent and tamper-proof, allowing for secure and efficient transactions between parties.

Smart contracts can be used across a wide range of industries and applications, from finance and real estate to supply chain management and more. They can automate routine tasks and remove the need for third-party intermediaries, reducing costs and increasing efficiency.

One of the most significant benefits of smart contracts is the increased trust they can create between parties. The terms of the contract are written into the code and cannot be altered without the agreement of all parties, providing transparency and certainty in transactions.

### SUMMARY

Disclosed herein provide systems and methods that enable a blockchain (BC) network to facilitate implementation of a certificate service system with a reward mechanism, where the blockchain network can issue reward to various contributing parties after the BC network validates that a consumer's purchase order and usage of certificates (e.g., coupons) has been validated or confirmed by a merchant. The merchant may purchase the certificate service from the BC network, for example, by paying fiat currency (e.g., through credit card payment) for a certain volume of “certificate coins” or “coupon coins” from the BC network. The reward can be in the form of BC ownership coin, or the cryptocurrency, which often has wildly fluctuating trading market value. According to embodiments of the present disclosure, the BC network can execute a smart contract allowing for certificate issuance independent of the cryptocurrency market value. In some embodiments, the certificate coins purchased by the merchant may be only tolled when a certificate is actually used by a consumer and the BC network validates the certificate usage. In some embodiments, the BC network validates if a certificate redemption request has been digitally signed both the consumer and the merchant in order to initiate the reward distribution. In this manner, the merchant only pays for the certificates that are converted to business revenue.

In some embodiments, the certificate coin value is determined independent of the ownership coin value. This can advantageously shields the merchant from price fluctuation in purchasing the certificate service and makes the business cost affordable and predictable. However, in some other embodiments, the certificate coin value is the same as the ownership coin value. For example, a merchant can purchase the coupon service from the BC network by using ownership coins directly, instead of fiat currency.

Further, the reward system, as implemented using a BC network system, provides an integrated platform that allows an individual entity to accumulate BC ownership coin reward for all kinds of economic transactions. In some embodiments, consumer can accumulate ownership coins for using certificates from all different merchants, including merchants of goods, services, etc. This can effectively stimulate adoption of the certificate service by both consumers and merchant.

Thus, the involved contributors (e.g., the consumer, the merchant, the employee of merchant, the blockchain validators, certificate service providers, and/or blockchain software developers, etc.) can earn and accumulate ownership coins through the verified actual business transactions between the merchant and the consumer. From the business perspective, this can create incentives for the contributors to participate the certificate service and to adopt such blockchain network platform.

Furthermore, the smart contract implemented as blockchain software program, in conjunction with cryptography technology and other technical implementations, ensures that all involved parties reliably perform the contract in concert, and certificate usage history is recorded and secured in a digital ledger in the blockchain.

Particularly, to enhance security of ownership coins that are valuable and scalable asset to the contributing parties, when a consumer places an eligible purchase order, the order is encrypted by a first key and concatenated with a first and a second encrypted keys. The first encrypted key can be the first key encrypted by a consumer public key and the second encrypted key can be the first key encrypted by a merchant public. The purchase order is maintained as private information by the BC network and only accessible to the consumer and merchant.

### BRIEF DESCRIPTION OF THE DRAWINGS

Embodiments of the present disclosure will be described, by way of example only, with reference to the accompanying drawings.

FIG. 1 is a block diagram that illustrates an exemplary blockchain (BC) network configured to facilitate merchant certificate distribution in accordance with an embodiment of the present disclosure.

FIG. 2 illustrates exemplary system and process of coupon distribution with ownership reward via a BC network in accordance with an embodiment of the present disclosure.

FIG. 3A illustrates an exemplary process of coupon redemption on BC network with an exemplary encryption mechanism according to an embodiment of the present disclosure.

FIG. 3B illustrates the information conversion involved in the exemplary encryption and decryption procedures.

FIG. 4 is a block diagram that illustrates an exemplary computer system that can be configured as a consumer device, a merchant device or a BC node according to embodiments of the present disclosure.

### DETAILED DESCRIPTION

Some embodiments of the present disclosure are described in great detail with reference to “coupon” and “coupon coin.” It will be appreciated that the disclosed systems and methods can be applied to any type of merchant certificates, such as coupons, promotions, gift certificates, vouchers, etc., without departing from the scope of the invention. “Ownership coins” and “cryptocurrency” are used interchangeably.

The blockchain (BC) network according to embodiments of the present disclosure includes a peer-to-peer network of nodes in communication with one another to participate in transactions and subsequently write the transactions to an associated blockchain. Each node is associated with at least one processor and at least one computer-readable medium having recorded thereon instructions to be executed by the processor(s) to carry out one or more blockchain-related tasks for creating, updating and/or maintaining at least one associated blockchain of the system based on the transactions as descried in greater detail below. Through the BC network, the BC nodes are communicatively coupled to a consumer device 191, a merchant device 192, a third party fiat currency payment system 160 (e.g., a credit card payment service platform) a coupon search service system 170, and other third party services and systems 180, such as advertisement service, storage service, or a point of sale (POS) system 180.

The merchant device 192 is associated with a merchant account on the BC network 100, and has a merchant software program operable to request the BC network to purchase coupon coins according to a coupon coin purchase smart contract 111 in response to user input. The device 192 is also operable to verify a purchase order received from a consumer device 191 by using digital signatures and send the coupon redemption request to the BC network.

The consumer device 191 is associated with a consumer account 135 on the BC network, and has a consumer software program operable to place a purchase order, and send a request for coupon redemption to the merchant device in response to user input.

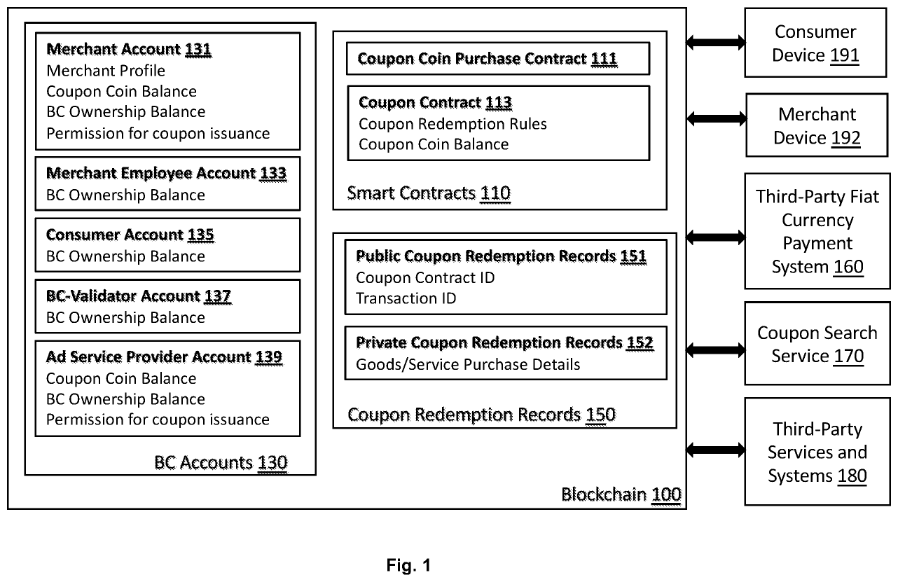

FIG. 1 is a block diagram that illustrates an exemplary blockchain (BC) network 100 configured to facilitate merchant certificate distribution in accordance with an embodiment of the present disclosure. Each node in the BC network 100 may be implemented in any type of node that is well known in the art, such as full node, pruned full mode, staking node, light node, etc.

In some embodiments, the BC network 100 is configured to maintain the account information of the parties participating in the secured execution of an exemplary certificate service system with a reward mechanism on the BC network. The accounts 130 described herein may include any other conceivable information without departing from the scope of the present disclosure. In some embodiments, the accounts each may be associated with an email address or a phone number.

The merchant has the account 131 associate with the BC network , which for example stores information of merchant profile, a balance of coupon coins, BC ownership balance, and/or permission for coupon issuance, etc. The merchant profile may include address, website, phone number, business description, business hours, and/or user's review of the business, etc. The merchant employee account 133, the consumer account 135 and BC-validator account 137 each can also maintain a BC ownership coin balance. An advertisement service provider account 139 can maintain a coupon coin balance, a BC ownership balance and permission for coupon issuance. In some embodiments, each the merchant account 131 and the consumer account 135 has both a private key and a public key. In one embodiment, a merchant account needs to get authorization from the blockchain network to be considered as a valid account.

As described in greater details below, in response to a merchant's request, the BC network 100 is operable to execute a smart contract, particularly a coupon coin purchase contract 111, to issue coupon coins to the merchant account 131, e.g., in exchange of fiat currency. The merchant can use the coupon coins to create a coupon contract 113. Once a merchant device receives a coupon redemption, it can validate the request digitally and sends a coupon redemption request (particularly, a merchant coupon redemption request) to the BC network. In some embodiments, the redemption request carries both the consumer's and merchant's digital signatures. The coupon redemption request may be submitted from a consumer device (e.g., for an online order) or the merchant device (e.g., for an in-person order). In some other embodiments, the certificate coin value can be the same as the ownership coin value. In some embodiments, a merchant can purchase the coupon service from the BC network by using ownership coins directly, instead of fiat currency.

Upon receiving the coupon redemption request, the BC network can execute the coupon contract 113, to validate the coupon usage transaction, e.g., based on the digital signatures of both the consumer and the merchant, keep track of the coupon usage, and accordingly issue reward in the form of ownership coins to the contributing parties. The reward can be issued to the contributing parties based on the coupon redemptions rules defined in the coupon contract. However, the coupon coin purchase and coupon redemption can be implemented in a single combined smart contract in some other embodiments.

In some embodiments, information pertinent to each coupon redemption transactions can be classified as private and public information separately and maintained as records 152 and 151 (150 collectively). The content of private record 151 is only accessible to the relevant merchant and consumer.

By executing coupon coin purchase contract 111, the BC network communicates with a fiat currency payment provider system 160 (e.g., hosted by Paypal, bank, merchant service, credit card, Apple pay, Stripe, Square etc.). Once the BC network receives payment confirmation from payment provider system 160, the smart contract 111 enables the BC network to deposit coupon coins to the merchant's account. The price of coupon coin in term of the fiat currency can be determined in any manner. In some embodiments, the price is published by the BC network such that the merchant's cost to issue coupon is predictable to the merchant.

Once the coupon contract 113 is created on the BC network, a third party coupon search service system 170 can access the contract and the associated merchant account information and make the information searchable by BC users. In some other embodiments, the BC network can be operable to publish the coupon and provide coupon search service. One or more third party service or systems 180 can be coupled with the BC network to provide various services to the consumers and merchants. The third party service or system can be advertisement service providers to facilitate the merchant to develop advertisement strategy, database and storage services to store business data, or a point of sale system for merchant etc.

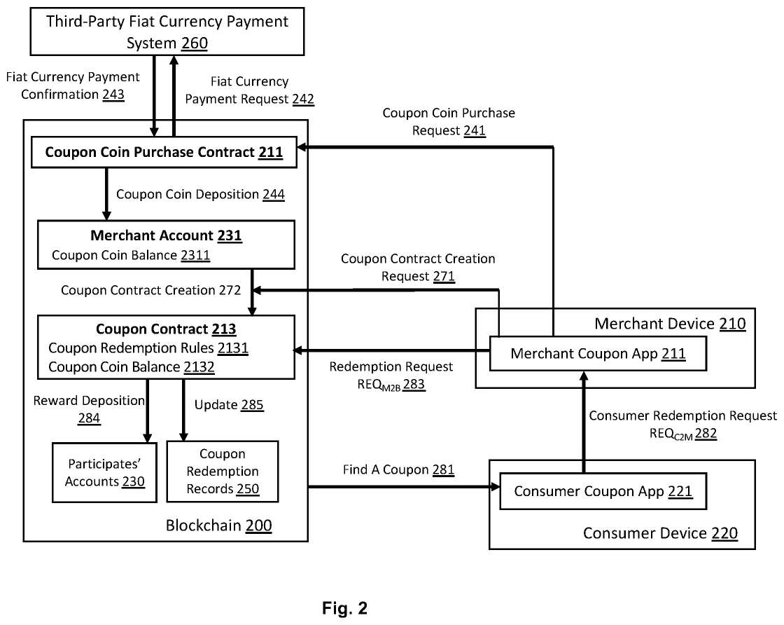

FIG. 2 illustrates exemplary system and process of merchant coupon distribution with ownership reward via a BC network 200 in accordance with an embodiment of the present disclosure. In this embodiment, the consumer device 220 and the merchant device 210 are respectively associated with a consumer account and a merchant account on the BC network 200 and are communicatively coupled to the BC network 200. For example, devices 210 and 220 are installed with a coupon application program (or “coupon app” herein) 211 and coupon application program 221 respectively.

The merchant device 210 may use the merchant coupon app 211 initiate a coupon coin purchase request 241 to the BC network to purchase coupon coins from the BC network in order to obtain BC network's service of administration, validation and reward of coupon usages. In response to the request 241, the BC network can execute the coupon coin purchase contract 211 (for example which may be pre-existent on the BC network) to deposit a certain volume of coupon coins to the merchant account 231, as in step 244. The execution of contract 211 may involve a fiat currency payment request 242 and confirmation 243 through the third party fiat currency payment system 260. In this manner, the BC network 200 charges the merchant account in a certain form of fiat currency and provide coupon coins.

The coupon app 211 may be configured to allow the merchant device to send a coupon contract creation request 271 for the BC network 200, specifying the coupon redemption rules 2131 as well as coupon coin balance 2132. The present disclosure is not limited to any specific forms or terms of coupon redemption rules or implementation the rules. In response, the BC network 200 creates a coupon contract 213 at step 272.

The consumer coupon app 221 enables the consumer device to communicate with the BC network 200 directly or communicates with a coupon search service. It can present active coupon contracts available on the BC network to the consumer in graphic user interface. The consumer coupon app 221 is configured to allow the consumer device 220 to send a request REQ_{C2M} 282 to the merchant device 210 to redeem a coupon, for example. The request REQ_{C2M} 282 may be prompted by the consumer user placing an eligible purchase order for certain goods or service provided by the merchant. The purchasing order may be placed through another shopping application program or website, and is communicated to the coupon app 221 on the merchant's end.

According to various embodiments of the present disclosure, a coupon redemption request REQ_{C2M} can be initiated by either a merchant device or a consume device. The redemption request REQ_{C2M} can be digitally signed by the merchant first and then the consumer, or in the opposite order. Thus, a coupon redemption order REQ_{M2B} can submitted (by either the merchant device or the consumer device) to the BC network and bears the signatures of both the merchant and the consumer. For example, upon receiving the redemption request 282, e.g., along with the purchase order, the coupon app 211 causes the merchant device 210 to send a redemption request REQ_{M2B} 283 to the BC network 200. In some other embodiments, the coupon app 211 in the merchant device 210 can generate an initial coupon redemption request REQ_{C2M} prompted by a purchase order placed on the merchant device 210, e.g., in an in-person or in-store order scenario. The merchant device 210 may then send the request REQ_{C2M} to the consumer device 220 for the consumer to sign by using consumer coupon app 221. The consumer device can directly submit the redemption request REQ_{M2B} to the BC network, or return the signed redemption REQ_{C2M} request to the merchant device 210 for the merchant device to submit the redemption request REQ_{M2B} 283 to the BC network.

Upon receiving the redemption request REQ_{M2B} 283, the BC network 200 can execute the corresponding coupon contract 213 according to the coupon redemption rules 2131. In some embodiments, the merchant device 210 may confirm the purchase order to the consumer user before sending the redemption request 283.

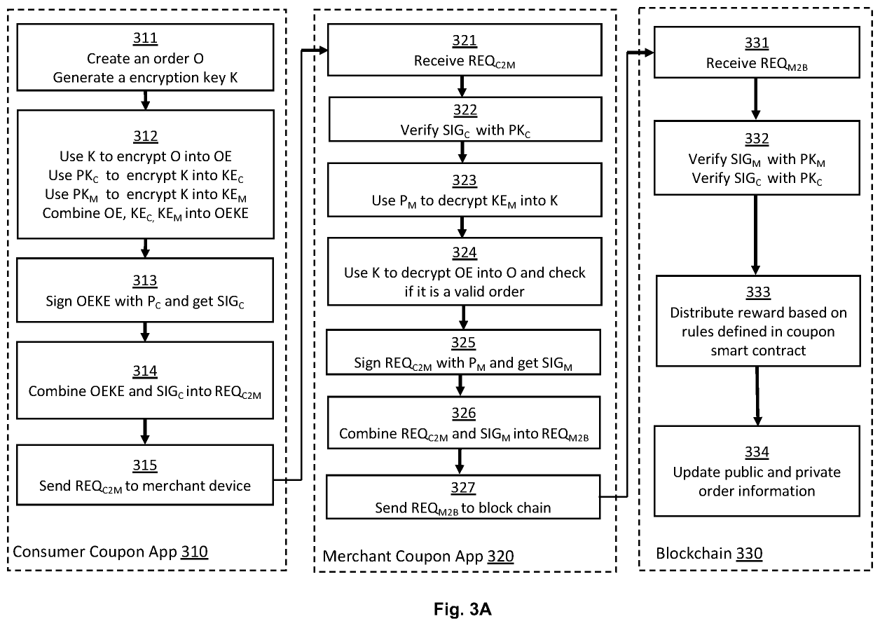

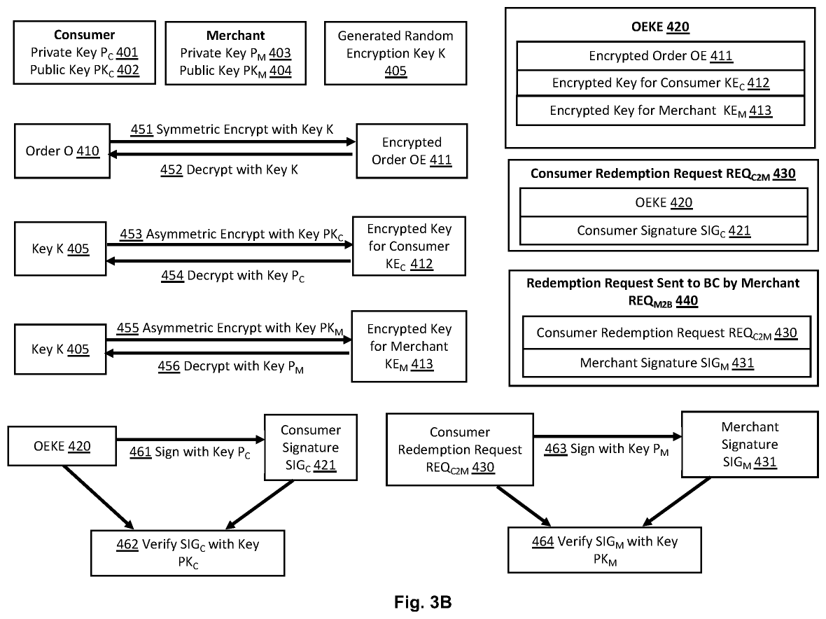

Executing of the coupon contract 210 includes validating the coupon usage (as described in greater detail with reference to FIGS. 3A and 3B below), and depositing reward to the accounts 230 of the participating parties as a result of coupon usage. The participants may include one or more of the consumer, the merchant, the employee of the merchant, the miner of validating the BC transactions, etc. In some embodiments, the reward is in the form of cryptocurrency of the BC network, or the ownership coins, that may be a tradable security. The coupon redemption record 250 of respective accounts may also be updated at step 285 as a result of the coupon contract 213 execution. According to embodiments of the present disclosure, the BC network executes the smart contracts to provides and records reward in the digital ledgers that inherently cannot be altered retroactively without the alteration of all subsequent blocks and the consensus of the network. The accumulated reward can be in in the form of cryptocurrency that is secured and tradable asset that are maintained in digital ledgers. Therefore, these can create strong incentive to the consumers to use coupons, to the merchants to use the coupon validation and reward service provided by the BC network.

To further ensure validity of coupon redemption transactions and protect data privacy of the associated accounts, in some embodiments, a coupon redemption request sent from the consumer app includes an encrypted order and encrypted keys, and a digital signature of the consumer. The coupon redemption request can then be verified, and signed by the merchant before it is sent to the BC network. Upon receiving the request from the merchant, the BC network can then verify the digital signatures and accordingly distribute the reward.

FIG. 3A illustrates an exemplary process of coupon redemption on BC network with an exemplary encryption mechanism according to an embodiment of the present disclosure. FIG. 3B illustrates the information conversion involved in the encryption and decryption procedures.

In this implementation, the consumer account is associated with a pair of keys, private key P_{C} 401 and public key PK_{C} 402 as in FIG. 3B; and the merchant account is also associated with a pair of keys, private key P_{M} 403 and public key PK_{M} 404 as in FIG. 3B. The private key P_{C} 401 or P_{M} 403 is maintained secret and only accessible to the consumer or merchant, while the public key PK_{C} or PK_{M} is public and accessible by the block chain network.

In the present embodiment, steps 311˜315 can be performed by the consumer coupon app 310. However, at described above regarding generation of the coupon redemption request REQ_{M2B}, it will be appreciated that some or all the procedures in the steps 311˜315 may be performed by the merchant coupon app 330 instead without departing from the scope of the present disclosure. In step 311, the consumer coupon app 310 receives consumer user's command to place a purchase order, and creates the order O (410 in FIG. 3B), e.g., in plain text format. The created order O 410 may include partial or entire information of the purchase order. For example, the order O 410 may not include some of the information in the purchase order that is irrelevant to coupon redemption, e.g., the consumer's address, email, phone number, credit card number, and other private information. The consumer app 310 also generates an encryption key K (405 in FIG. 3B), e.g., a random encryption key.

In step 312, the plain text order O can be converted into cipher text format OE (411 in FIG. 3B) with the encryption key K 405 through a symmetric encryption procedure (shown as 20 451 in FIG. 3B). The cipher text OE can be decrypted by the same key K into the plain text order O (shown as procedure 452 in FIG. 3B). The consumer app also converts the encryption K (405 in FIG. 3B) into cipher text format KE_{C} (412 in FIG. 3B) and KE_{M} (413 in FIG. 3B). KE_{C} is generated using the consumer's public key PK_{C} 401 through an asymmetric encryption procedure (453 in FIG. 3B). KE_{C} can be decrypted into key K by the consumer's private key P_{C} 402 through a decryption procedure (454 in FIG. 3B). Similarly, KE_{M} is generated using the merchant's public key PK_{M} 403 with an asymmetric encryption procedure (455 in FIG. 3B). KE_{M} can be decrypted into key K by the merchant's private key P_{M} 403 through a decryption procedure (456 in FIG. 3B). After OE 411, KE_{C} 412 and KE_{M} 413 are generated, the consumer app can combine them into one document OEKE (420 in FIG. 3B). For example, OE 411, KE_{C} 412 and KE_{M} 413 concatenated into document OEKE 420. In some embodiments, OEKE may additionally contain plain text order or other meta data of the order.

The consumer can sign the OEKE document with the private key P_{C}. Particularly, in step 313, the consumer app generates a digital signature SIG_{C} (421 in FIG. 3B) of document OEKE 420 using the consumer's private key P_{C} 401. SIG_{C} can be a digital signature of document OEKE itself or a digital signature of a hash value of document OEKE. The digital signature generation procedure is shown as 461 in FIG. 3B.

In step 314, document OEKE 420 and consumer's signature SIG_{C} 421 are combined into a request document REQ_{C2M} (430 in FIG. 3B).

In step 315, the consumer coupon app 310 sends the request REQ_{C2M} 430 to the merchant coupon app 320. The request can be transmitted through internet, WIFI, Bluetooth, or near field communication. The consumer app 310 can also encode request REQ_{C2M} 430 or a unique identifier of REQ_{C2M} 430 into a QR Code or a bar code for the merchant app 320 to scan. The consumer app 310 and merchant app 320 may communicate directly or through a remote server.

Steps 321˜327 can be performed by the merchant coupon app 320. In step 321, the merchant app 320 receives request the REQ_{C2M} 430 from the consumer's app 310.

In step 322, the merchant app 320 verifies the consumer's signature SIG_{C} 421 with the consumer's public key PK_{C} 401 and make sure the request is indeed from the consumer and is not tampered. This signature verification procedure is shown as 462 in FIG. 3B.

In step 323, the merchant app decrypts KE_{M} 413 into key K 405 using the merchant's private key P_{M} 403.

In step 324, the key K 405 is used to decrypt OE 411 into the plain text order O 410. The merchant app can render the order O in a graphical user interface. The merchant user can validate the order and confirm the order is qualified for the coupon redemption.

In step 325, the merchant app 320 generates a digital signature SIG_{M} 431 of REQ_{C2M} 430 using the merchant's private key P_{M} 403. SIG_{M} can be the digital signature of REQ_{C2M} itself or the digital signature of a hash value of REQ_{C2M}. The digital signature generation procedure is shown as 463 in FIG. 3B.

In step 326, the merchant app combines REQ_{C2M} 430 and SIG_{M} 431 into a request document REQ_{M2B} 440. Thus, the REQ_{M2B} 440 includes the encrypted order 411, encrypted keys 412 and 413, signatures 421 and 431. These information in REQ_{M2B} 440 can be arranged in a nested structured, such JSON, XML, or binary format. In one embodiment, REQ_{M2B} 440 can contain extra digital signatures, for example the signature of the merchant employee who operates the merchant app.

In step 327, the request document REQ_{M2B} 440 is sent to the block chain network 330 through the internet.

Steps 331˜334 can be performed by the BC network, particularly, by one or more of the BC network nodes. In step 331, the block chain network 330 receives REQ_{M2B} 440.

In step 332, the block chain network verifies SIG_{M} using merchant's public key PKM (as the procedure 464 in FIG. 3B) and verifies SIG_{C} using the consumer's public key PKC (as the procedure 462 in FIG. 3B).

Once the signatures in REQ_{M2B} are verified, the block chain network executes the coupon smart contract in step 333. The coupon coins are deducted from the coupon coin balance of the coupon smart contract and converted into block chain ownership coins and distributed to the participants according to the rules defined in the coupon smart contract. The participants can contain the consumer, the merchant owner, the merchant employee, etc.

In step 334, the block chain network updates the public and private order information according to the execution of the coupon smart contract triggered by REQ_{M2B}. Example of public order information includes the total number of orders and the total reward generated by the given coupon smart contract. Example of private order information includes the order details. In one embodiment, REQ_{M2B} can be saved as the private order information. The public order information is accessible by all users of the block chain network. The private order information is accessible only by the consumer and the merchant of the order. In one embodiment, the private order information can be saved in a third-party storage service provider instead of in the block chain network.

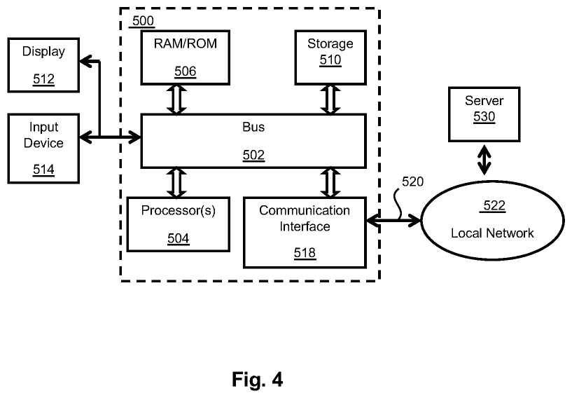

FIG. 4 is a block diagram that illustrates an exemplary computer system 500 that can be configured as a consumer device, a merchant device or a BC node according to embodiments of the present disclosure. The computer system 500 may be used to implement any of the entities, components, modules, or services depicted in the examples of the figures (and any other entities, components, modules, or services described in this specification). The computer system 500 may be programmed to execute computer program instructions to perform functions, methods, flows, or services (e.g., of any of the entities, components, or modules) described herein. The computer system 500 may be programmed to execute computer program instructions by at least one of software, hardware, or firmware.

Computer system 500 includes a bus 502 or other communication mechanism for communicating information, and one or more processor(s) 504 coupled with bus 502 for processing information. Computer system 500 also includes a memory 506, such as a random-access memory (RAM) or other dynamic storage device, coupled to bus 502 for storing information and instructions to be executed by processor 504. The memory 506 also may be used for storing temporary variables or other intermediate information during execution of instructions to be executed by processor(s) 504. The memory 506 further includes a read only memory (ROM) or other static storage device coupled to bus 502 for storing static information and instructions for processor 504. A storage device 510, such as a magnetic/optical disk or solid state drive (SSD), is provided and coupled to bus 502 for storing information and instructions.

Computer system 500 may be coupled via bus 502 to a display 512, such as a flat panel or touch panel display for displaying information to a computer user. An input device 514, including alphanumeric and other keys, is coupled to bus 502 for communicating information and command selections to processor 504. Another type of user input device is cursor control, such as a touchscreen, mouse, a trackball, or cursor direction keys for communicating direction information and command selections to processor 504 and for controlling cursor movement on display 512.

According to one embodiment, portions of one or more methods described herein may be performed by computer system 500 in response to processor 504 executing one or more sequences of one or more instructions contained in the memory 506. For example, in case the computer system 500 is a consumer device, a merchant device, or a BC network node, the consumer app, the merchant app, or a BC app is stored in the memory and configured to perform the respective processes as described herein. Such instructions may be read into memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In an alternative embodiment, hard-wired circuitry may be used in place of or in combination with software instructions. Thus, the description herein is not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media include, for example, magnetic/optical disk or SSD, such as storage device 510. Volatile media include dynamic memory, such as memory 506. Transmission media include coaxial cables, copper wire and fiber optics, including the wires that comprise bus 502. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be borne on a magnetic disk of a remote computer. The remote computer can load the instructions into its dynamic memory and send the instructions over a network link using a modem. A modem local to computer system 500 can receive the data on the network link and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also preferably includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of network cable. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Computer system 500 can send messages and receive data, including program code, through the network(s), network link, and communication interface 518.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

It should be understood that the description and the drawings are not intended to limit the present disclosure to the particular form disclosed, but to the contrary, the intention is to cover all modifications, equivalents, and alternatives falling within the spirit and scope of the inventions as defined by the appended claims.

Modifications and alternative embodiments of various aspects of the inventions will be apparent to those skilled in the art in view of this description. Accordingly, this description and the drawings are to be construed as illustrative only and are for the purpose of teaching those skilled in the art the general manner of carrying out the inventions. It is to be understood that the forms of the inventions shown and described herein are to be taken as examples of embodiments. Elements and materials may be substituted for those illustrated and described herein, parts and processes may be reversed or omitted, certain features may be utilized independently, and embodiments or features of embodiments may be combined, all as would be apparent to one skilled in the art after having the benefit of this description. Changes may be made in the elements described herein without departing from the spirit and scope of the invention as described in the following claims. Headings used herein are for organizational purposes only and are not meant to be used to limit the scope of the description.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

What is claimed is:

1. A non-transitory computer-readable medium having instructions recorded thereon, the instructions when executed by a processor communicatively coupled to a blockchain network, cause the processor to perform a method of facilitating merchant certificate distribution through the blockchain network, the method comprising:
receiving a first certificate redemption request comprising:
an order document comprising an encrypted order, a first and a second encrypted keys, wherein the first encrypted key corresponds to first key encrypted by a first public key associated with a consumer account, wherein the second encrypted key corresponds to the first key encrypted by a second public key associated with a merchant account, wherein the encrypted order corresponds to a purchase order for a goods or service that is encrypted by the first key;
a digital consumer signature generated by using a first private key associated with the consumer account; and
a digital merchant signature generated by using a second private key associated with the merchant account;
validating the first certificate redemption request using the first public key and the second public key;
in response to successful validation of the first certificate redemption request, issuing reward by executing a first smart contract on the blockchain network.

2. The medium of claim 1, further comprising maintaining information contained in the first certificate redemption request as private information accessible to the consumer and the merchant accounts.

3. The medium of claim 1, wherein the digital consumer signature is signed for the order document by using the first private key, wherein a second certificate redemption request is generated and comprises the order document and the digital consumer signature, and wherein the digital merchant signature is signed for the second certificate redemption request.

4. The medium of claim 3, wherein the first certificate redemption request is generated at a merchant's device and comprises the digital merchant signature and the second certificate redemption request.

5. The medium of claim 1, wherein the digital merchant signature is signed for the order document by using the second private key, wherein a second certificate redemption request is generated and comprises the order document and the digital merchant signature, and wherein the digital consumer signature is signed for the second certificate redemption request.

6. The medium of claim 5, wherein the first certificate redemption request is generated at a consumer device and comprises the digital consumer signature and the second certificate redemption request.

7. The medium of claim 1, wherein the first certificate redemption request is sent from a consumer device or a merchant device.

8. The medium of claim 1, wherein the order document further comprises meta data associated with the purchase order.

9. The medium of claim 1, wherein the encrypted order is symmetrically encrypted by the first key.

10. The medium of claim 1, wherein the first key is asymmetrically encrypted by a public key associated with the consumer account.

11. The medium of claim 1, wherein the first smart contract indicates a balance of certificate coins, and wherein the executing the first smart contract further comprises deducting the certificate coins from the balance.

12. The medium of claim 1, wherein the distributing the reward comprises updating decentralized ledgers with cryptocurrency ownership coins associated with the merchant account, the customer account and a blockchain validator account that participate in validation.

13. The medium of claim 12, wherein the cryptocurrency ownership coins are determined based on a conversion rate between cryptocurrency ownership coin and certificate coin, and further based on deducted certificate coins.

14. The medium of claim 1, further comprising:
receiving a certificate purchase request from a merchant device for purchasing certificate coins by using fiat currency; and
executing a second smart contract to deposit certificate coins to the merchant account.

15. The medium of claim 1, wherein the first smart contract specifies a rule of reward distribution in relation to the purchase order.

16. The medium of claim 1, wherein the cryptocurrency ownership coin is the same or different than the certificate coin.
